(19) United States
(12) Patent Application Publication
(10) Pub. No.: US 2009/0315858 A1
(43) Pub. Date: Dec. 24, 2009

(54) Display Device with Touch Panel

(75) Inventors: Hideo Sato, Hitachi (JP); Shigeyuki Nishitani, Mobara (JP); Teruaki Saito, Mobara (JP); Norio Mamba, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/486,003

(22) Filed: Jun. 17, 2009

(30) Foreign Application Priority Data
Jun. 19, 2008 (JP) 2008-160272

(51) Int. Cl. G06F 3/044

(52) U.S. Cl. 345/174

(57) ABSTRACT

A present display device with a highly reliable capacitive touch panel includes: a display panel; and a capacitive touch panel which is placed on an observer side of the display panel, in which the touch panel includes a first substrate and a second substrate which are arranged to face each other, in which the first substrate includes on a surface thereof, which is opposed to the second substrate: a plurality of first electrodes which extend in a first direction side by side; and a plurality of second electrodes which extend in the second direction to intersect the plurality of first electrodes side by side, in which the second substrate includes on a surface thereof, which is opposed to the first substrate a planar third electrode, and the display device includes a gel-like sheet interposed between the plurality of first electrodes and the plurality of second electrodes, and the third electrode.

### CROSS-REFERENCE TO RELATED APPLICATION

The present application claims priority from Japanese application JP 2008-160272 filed on Jun. 19, 2008, the content of which is hereby incorporated by reference into this application.

### BACKGROUND OF THE INVENTION

1. Field of the Invention

The present invention relates to a display device with a touch panel, and more particularly, to a technology effectively applicable to a display device with a touch panel that is a capacitive touch panel.

2. Description of the Related Art

In recent years, a touch panel technology that supports human-conscious graphical user interfaces has played a pivotal role in prevalence of mobile equipment.

As the touch panel technology, a capacitive touch panel is known. As the capacitive touch panel, a touch panel that detects a plurality of touch points touched by an observer is known (see JP 08-16307 A).

In the touch panel disclosed in JP 8-16307 A, a demultiplexer and a multiplexer are provided around a tablet, and the demultiplexer and the multiplexer are sequentially switched to detect coupling capacitors of an electrode line in an X direction and an electrode line in a Y direction and detect coordinates of a plurality of touch points touched by the observer.

A common capacitive touch panel includes a plurality of X electrodes, which run in a first direction (for example, Y direction) and are arranged side by side in a second direction intersecting the first direction (for example, X direction), and a plurality of Y electrodes, which run in the second direction to intersect with the X electrodes and are arranged side by side in the first direction. The plurality of X electrodes and Y electrodes are laminated on a substrate with an interlayer insulating film interposed between the X electrodes and the Y electrodes, and are formed from a transparent conductive material such as indium tin oxide (ITO).

Two input methods for capacitive touch panels are known. One is a finger touch input method in which the coordinates of a touch point are input by touching the touch face of the touch panel with an observer's finger, and the other is a stylus pen input method in which the coordinates of a touch point are input by touching the touch face of the touch panel with a stylus pen.

The above-mentioned capacitive touch panels require an observer to touch areas above an X electrode and a Y electrode simultaneously in order to detect the coordinates of the touch point. This is not particularly a problem in the finger touch input method where the contact area between the touch face of the touch panel and the observer's finger is relatively large.

In the stylus pen input method, on the other hand, the contact area between the touch face of the touch panel and the stylus pen is smaller than in the finger touch input method, and touching areas above an X electrode and a Y electrode simultaneously is not so easy, which makes it difficult to detect a capacitance difference between the coupling capacitors of the X electrode and the Y electrode.

Touching areas above an X electrode and a Y electrode simultaneously with a stylus pen could be facilitated by miniaturizing the X electrodes and the Y electrodes so that the contact area between the touch face of the touch panel and the stylus pen would be larger than the size of a pair of intersecting X electrode and Y electrode. However, miniaturizing the X electrodes and the Y electrodes lowers the sensitivity, thereby giving rise to a problem of low S/N ratio.

### SUMMARY OF THE INVENTION

The inventors of the present invention have taken notice of the fact that deformation of a touch panel caused by touching the touch panel on its touch face with a stylus pen changes a capacitance, which resulted in the present invention.

An object of the present invention is to provide a display device with a highly reliable capacitive touch panel that can process finger touch input and stylus pen input.

Of aspects of the present invention disclosed herein, the representative ones are briefly sketched as follows.

(1) A display device includes:

a display panel; and

a capacitive touch panel which is placed on an observer side of the display panel,

in which the touch panel includes a first substrate and a second substrate which are arranged to face each other,

in which the first substrate includes on a surface thereof, which is opposed to the second substrate:
a plurality of first electrodes which extend in a first direction and are arranged side by side in a second direction intersecting the first direction; and
a plurality of second electrodes which extend in the second direction to intersect the plurality of first electrodes and are arranged side by side in the first direction,

in which the second substrate includes on a surface thereof, which is opposed to the first substrate a planar third electrode which covers the plurality of first electrodes and the plurality of second electrodes, and

in which the display device includes a gel-like sheet interposed between the plurality of first electrodes and the plurality of second electrodes, and the third electrode.

(2) In the above-mentioned Item (1), the gel-like sheet has a hardness of 2 or more and 15 or less.

(3) In the above-mentioned Item (1), the first substrate and the second substrate are each a glass substrate, and the second substrate is thinner than the first substrate.

(4) In the above-mentioned Item (1), the first substrate is a glass substrate, and the second substrate is a plastic substrate.

(5) In the above-mentioned Item (1), the first substrate and the second substrate are each a plastic substrate.

(6) A display device includes:

a display panel; and

a capacitive touch panel which is placed on an observer side of the display panel,

in which the touch panel includes a first substrate and a second substrate which are arranged to face each other,

in which the first substrate includes on a surface thereof, which is opposed to the second substrate a plurality of first electrodes which extend in a first direction and are arranged side by side in a second direction intersecting the first direction,

in which the second substrate includes on a surface thereof, which is opposed to the first substrate a plurality of second electrodes which extend in the second direction to intersect the plurality of first electrodes and are arranged side by side in the first direction, and

in which the display device includes a gel-like sheet interposed between the plurality of first electrodes and the plurality of second electrodes.

(7) In the above-mentioned Item (6), the gel-like sheet has a hardness of 2 or more and 15 or less.

(8) In the above-mentioned Item (6), the first and second substrates are each a glass substrate, and the second substrate is thinner than the first substrate.

(9) In the above-mentioned Item (6), the first substrate is a glass substrate, and the second substrate is a plastic substrate.

(10) In the above-mentioned Item (6), the first substrate and the second substrate are each a plastic substrate.

Effects that are obtained by the representative one of the aspects of the present invention disclosed herein are summarized as follows.

According to the present invention, there is provided a display device with a highly reliable, capacitive touch panel that can process finger touch input and stylus pen input.

The above-mentioned and other objects and novel features of the present invention are clarified through a description given herein and accompanying drawings.

### BRIEF DESCRIPTION OF THE DRAWINGS

In the accompanying drawings:

FIG. 1 is a sectional view illustrating a schematic structure of a touch panel that is incorporated in a display device with a touch panel according to a first embodiment of the present invention;

FIG. 2 is a plan view illustrating an electrode pattern of the touch panel of FIG. 1;

FIG. 3 is a sectional view that is an enlarged view of part of FIG. 1;

FIG. 4 is a block diagram illustrating a driving circuit of the touch panel of FIG. 1;

FIG. 5 is a block diagram illustrating a schematic structure of the display device with a touch panel according to the first embodiment of the present invention;

FIG. 6 is a diagram of a Y driving circuit illustrated in FIG. 4;

FIG. 7 is a diagram of an X detecting circuit illustrated in FIG. 4;

FIG. 8 is a timing chart illustrating the way the touch panel of FIG. 4 operates;

FIG. 9 is a block diagram illustrating a schematic structure of a touch panel that is used in a liquid crystal display device with a touch panel according to a second embodiment of the present invention;

FIG. 10 is a diagram of an electrode driving circuit illustrated in FIG. 9;

FIG. 11 is a diagram of a current detecting circuit illustrated in FIG. 9;

FIG. 12 is a sectional view illustrating a schematic structure of a touch panel that is incorporated in a display device with a touch panel according to a third embodiment of the present invention;

FIG. 13 is a plan view illustrating an electrode pattern of the touch panel of FIG. 12;

FIG. 14 is a sectional view that is an enlarged view of part of FIG. 12;

FIG. 15 is a block diagram illustrating driving circuits of the touch panel of FIG. 12;

FIG. 16 is a diagram illustrating the current detecting circuit of FIG. 11; and

FIG. 17 is a timing chart illustrating the way the current detecting circuit of FIG. 16 operates.

### DETAILED DESCRIPTION OF THE INVENTION

Embodiments of the present invention are described below in detail with reference to the drawings. Throughout the drawings illustrating the embodiments of the present invention, components that have the same function are denoted by the same reference symbol in order to avoid repetitive description.

### First Embodiment

A first embodiment deals with a case of applying the present invention to a display device with a capacitive touch panel that includes a touch panel on a liquid crystal display panel as an example of a display panel.

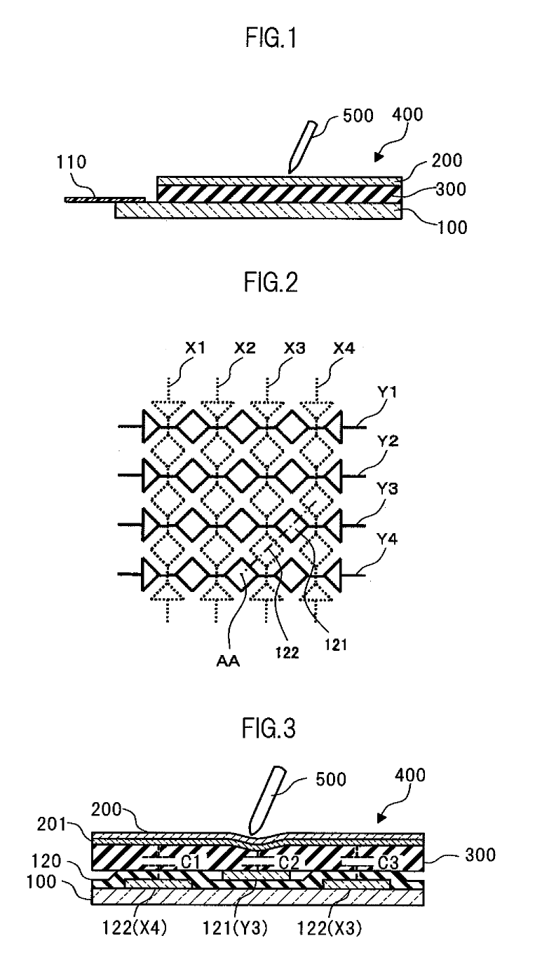

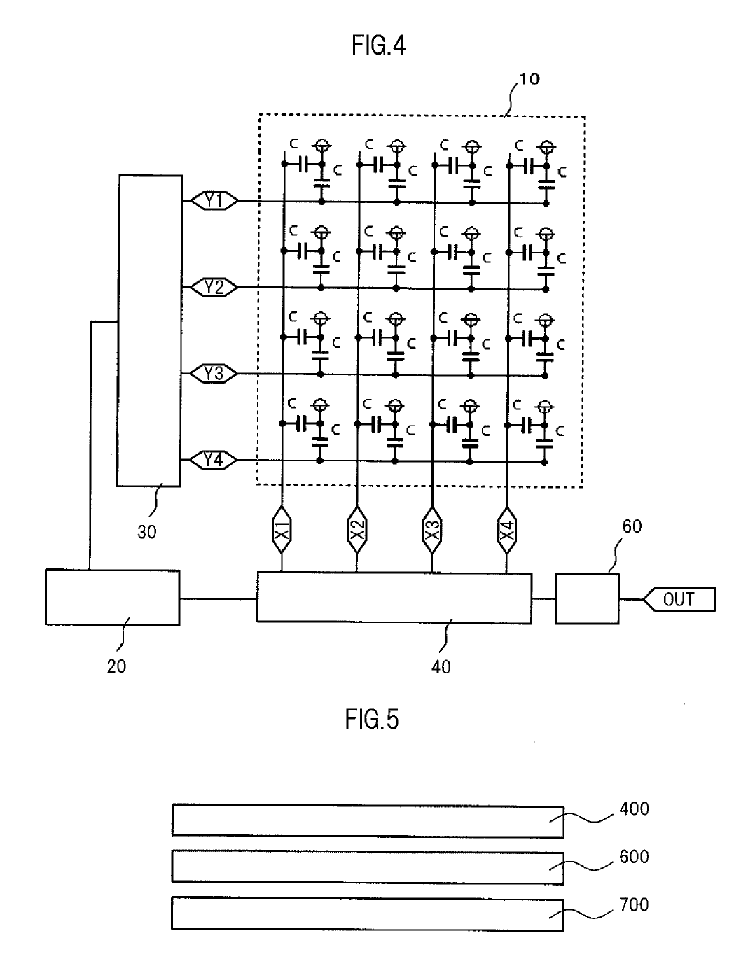

FIGS. 1 to 5 are diagrams about a display device with a touch panel according to the first embodiment of the present invention. FIG. 1 is a sectional view illustrating a schematic structure of a touch panel that is incorporated in the display device with a touch panel. FIG. 2 is a plan view illustrating an electrode pattern of the touch panel of FIG. 1. FIG. 3 is a sectional view that is an enlarged view of part of FIG. 1. FIG. 4 is a block diagram illustrating a driving circuit of the touch panel of FIG. 1. FIG. 5 is a block diagram illustrating a schematic structure of the display device with a touch panel.

The display device with a touch panel of the first embodiment includes, as illustrated in FIG. 5, a liquid crystal display panel 600, a capacitive touch panel 400, which is placed on an observer side of the liquid crystal display panel 600, and a backlight 700, which is placed under the opposite side of the liquid crystal display panel 600 from the observer side. The liquid crystal display panel 600 can be an IPS liquid crystal display panel, a TN liquid crystal display panel, or a VA liquid crystal display panel, for example.

The touch panel 400 includes, as illustrated in FIG. 1, first and second substrates (100 and 200, respectively), which are arranged to face each other, a gel-like sheet 300, which is held between the first substrate 100 and the second substrate 200, and a flexible printed circuit (FPC) board 110, which is fixed at one end to one of the four sides of a substrate opposing face of the first substrate 100 (a face that is opposed to the second substrate 200).

As illustrated in FIG. 2, the touch panel 400 includes a plurality of X electrodes (X1 to X4), which run in a first direction (for example, Y direction) and are arranged side by side at a given alignment pitch in a second direction (for example, X direction) intersecting the first direction, and a plurality of Y electrodes (Y1 to Y4), which run in the second direction to intersect with the X electrodes and are arranged side by side at a given alignment pitch in the first direction.

The X electrodes X1 to X4 are formed in an electrode pattern that places a plurality of first parts and a plurality of second parts 122 wider than the first parts alternately in the first direction (Y direction, for example) in a touch panel region 10.

The Y electrodes Y1 to Y4 are formed in an electrode pattern that places a plurality of first parts and a plurality of second parts 121 wider than the first parts alternately in the second direction (X direction, for example) in the touch panel region 10.

The second parts 122 of the X electrodes X1 to X4 are each placed, in plan view, between two adjacent Y electrodes. The second parts 121 of the Y electrodes Y1 to Y4 are each placed, in plan view, between two adjacent X electrodes. The first parts of the X electrodes X1 to X4 respectively intersect with the first parts of the Y electrodes Y1 to Y4 in plan view.

The first substrate 100 includes the X electrodes X1 to X4 and the Y electrodes Y1 to Y4, which are, as illustrated in FIG. 3, laminated on a face of the first substrate 100 that is opposed to the second substrate 200, with an insulating film 120 interposed between the X electrodes and the Y electrodes. In the example of this embodiment, the Y electrodes constitute an upper layer above the X electrodes which constitute a lower layer.

As illustrated in FIG. 3, the second substrate 200 includes a planar counter electrode 201 on its face that is opposed to the first substrate 100. The counter electrode 201 is formed so as to cover at least all of the X electrodes and the Y electrodes in the touch panel region 10.

The X electrodes (X1 to X4), the Y electrodes (Y1 to Y4), and the counter electrode 201 are formed from a transparent conductive material such as indium tin oxide (ITO).

The gel-like sheet 300 is provided between the X electrodes and the Y electrodes on the first substrate 100 and the counter electrode 201 on the second substrate 200 as illustrated in FIG. 3. The gel-like sheet 300 is formed so as to cover at least all of the X electrodes and the Y electrodes in the touch panel region 10. The gel-sheet 300 of this embodiment is formed on the side of the second substrate 200, but the placement of the gel-sheet 300 is not limited thereto.

The substrates employed as the first substrate 100 and the second substrate 200 are transparent insulating substrates. The first and second substrates (100 and 200) of this embodiment are glass substrates, and the second substrate 200 is thinner than the first substrate 100.

The material of the gel-like sheet 300 can be paraffin-based oil or a silicone rubber-based material, for example.

FIG. 3 schematically illustrates that capacitors C1, C2, and C3 are formed between the counter electrode 201 and the X electrode X4, between the counter electrode 201 and the Y electrode Y3, and between the counter electrode 201 and the X electrode X3, respectively.

When an observer touches a touch face of the thus structured touch panel 400 (the touch face of the second substrate 200) with a stylus pen 500 as illustrated in FIG. 3, the second substrate 200 is deformed and the deformation is followed up by the displacement of the gel-like sheet 300 (a change in thickness of the gel-like sheet 300), which changes the capacitance between the electrode (X electrode or Y electrode) on the first substrate 100 and the counter electrode 201 on the second substrate 200. In FIG. 3 where an area above the Y electrode Y3 is touched with the stylus pen 500, the capacitance between the Y electrode Y3 and the counter electrode 201 changes. This change in capacitance is detected to detect a point that the stylus pen has touched.

The above-mentioned change in capacitance is caused by the displacement of the gel-like sheet 300. Touch input is therefore accomplished also with an observer's finger, a stick with a rounded tip, or the like.

Further, the presence or absence of a touch is detected from a change in capacitance, and hence a contact between electrodes as in resistive touch panels is avoided and the touch panel 400 can therefore have high reliability.

A display device with a highly reliable, capacitive touch panel that can process finger touch input and stylus pen input is thus provided.

The hardness of the gel-like sheet 300 is desirably 2 or more and 15 or less in order to obtain a necessary change in capacitance.

FIG. 4 is a block diagram illustrating a driving circuit of the touch panel. In FIG. 4, a touch panel region (touch sensor region) is denoted by 10, a control circuit is denoted by 20, a Y driving circuit is denoted by 30, an X detecting circuit is denoted by 40, and a coordinate detecting circuit is denoted by 60. Reference symbols X1 to X4 represent X electrodes running in the first direction (the Y direction of FIG. 1). Reference symbols Y1 to Y4 represent Y electrodes running in the second direction (the X direction of FIG. 1). Reference symbol C represents coupling capacitors formed from the X electrodes, the Y electrodes, and the counter electrode 201.

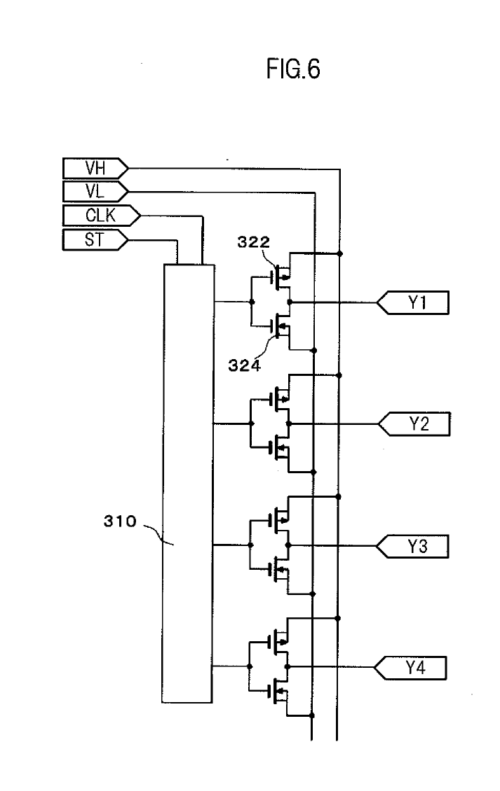

FIG. 6 is a diagram of the Y driving circuit 30 illustrated in FIG. 4.

As illustrated in FIG. 6, the Y driving circuit 30 includes a shift register 310. When the output of each shift stage of the shift register 310 is High (hereinafter referred to as H level), pMOS transistors 322 are turned off and nMOS transistors 324 are turned on, whereby a reference voltage (here, voltage VL) is supplied to the Y electrodes Y1 to Y4.

When the output of each shift stage of the shift register 310 is Low (hereinafter referred to as L level), the pMOS transistors 322 are turned on and the nMOS transistors 324 are turned off, whereby a voltage higher in potential than the reference voltage (here, voltage VH) is supplied to the Y electrodes Y1 to Y4.

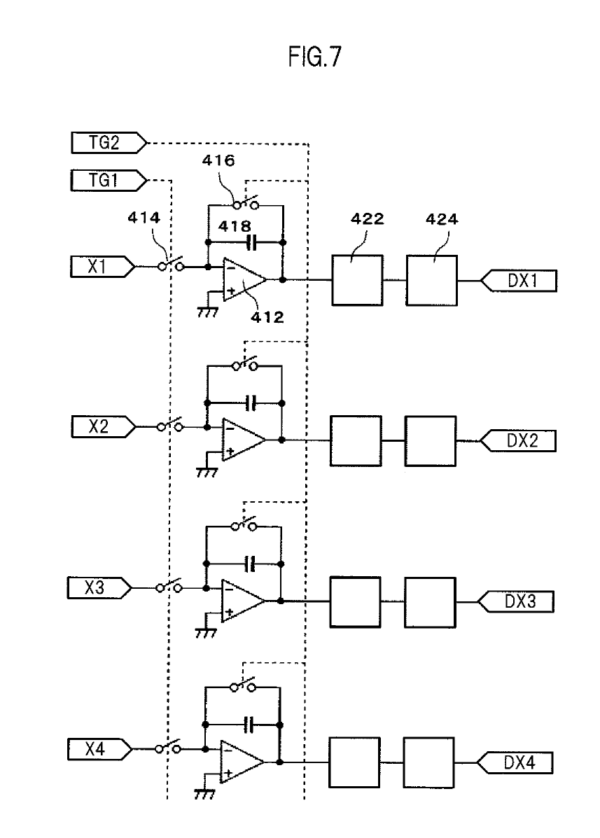

FIG. 7 is a diagram of the X detecting circuit 40 illustrated in FIG. 4.

As illustrated in FIG. 7, the X detecting circuit 40 includes integration circuits each including an operational amplifier 412 and an integration capacitor 418. A sample-and-hold circuit 422 and an A/D conversion circuit 424 are provided downstream of the integration circuit.

The integration circuit integrates currents that flow in the X electrodes X1 to X4 when the voltage supplied to the Y electrodes Y1 to Y4 changes from the H level to the L level, or from the L level to the H level, while a switching device 414 is on. The integration capacitor 418 of the integration circuit is reset when a switching device 416 is on.

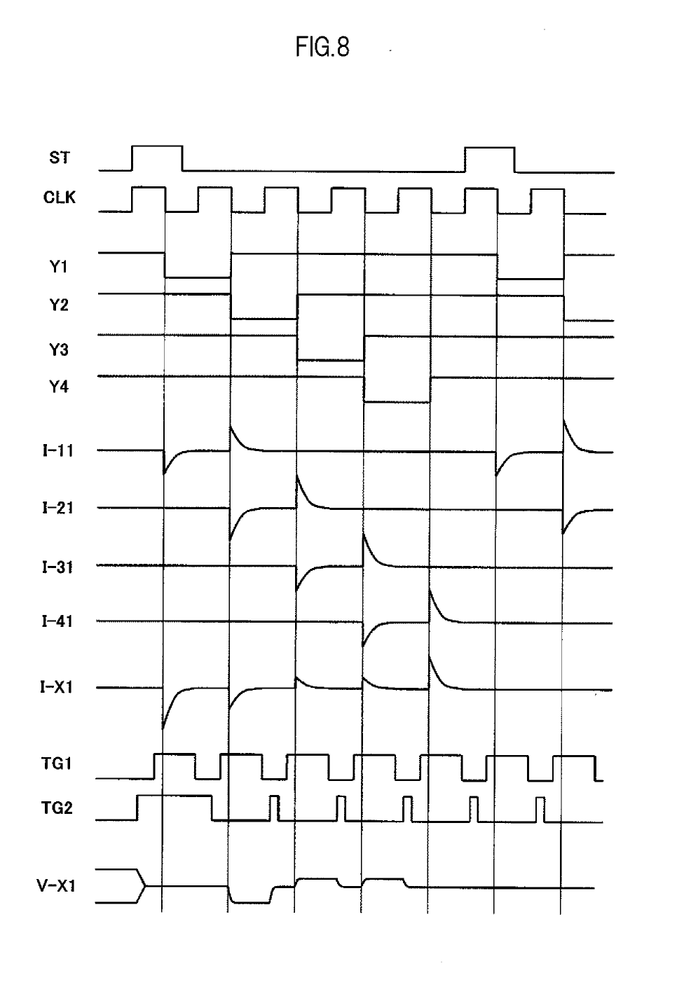

FIG. 8 is a timing chart illustrating the way the touch panel of FIG. 4 operates.

A start pulse ST and a clock CLK are input to the shift register 310 of the Y driving circuit 30 to supply the L-level voltage to the Y electrodes Y1 to Y4 sequentially.

When the voltage of the Y electrodes Y1 to Y4 changes from the H level to the L level, and when the voltage of the Y electrodes Y1 to Y4 changes from the L level to the H level, currents flow separately from the Y electrodes Y1 to Y4 to the X electrodes X1 to X4.

These currents are detected in the X electrodes. For instance, currents denoted by I-11, I-21, I-31, and I-41 of FIG. 8 flow from the Y electrodes Y1 to Y4 to the X electrode X1. As a result, a current denoted by I-X1 of FIG. 8 which is the sum of these currents I-11, I-21, I-31, and I-41 flows in the X electrode X1. The current I-X1 is integrated by the integration circuit to detect a voltage denoted by V-X1 of FIG. 8. The switching device 414 is turned on with a timing pulse TG1, and the switching device 416 is turned on with a timing pulse TG2.

In this embodiment, when an X electrode and a Y electrode have the same coupling capacitance, a current caused to flow in the X electrode by a change from the L level to the H level of the voltage of the Y electrode Y1 and a current caused to flow in the X electrode by a change from the H level to the L level of the voltage of the Y electrode Y2 are opposite to each other in terms of current direction and equal to each other in terms of current amount. The output voltage of the integration circuit in this case is therefore 0. When an X electrode and a Y electrode have different coupling capacitances, on the other hand, a current caused to flow in the X electrode by a change from the L level to the H level of the voltage of the Y electrode Y1 and a current caused to flow in the X electrode by a change from the H level to the L level of the voltage of the Y electrode Y2 are opposite to each other in terms of current direction and different from each other in terms of current amount, with the difference in current amount reflecting the difference in capacitance. The output voltage of the integration circuit in this case is therefore other than 0.

The integration circuit, which integrates current values detected in its associated X electrode, outputs a voltage that is in proportion to a capacitance difference between the coupling capacitors of the X electrode and the intersecting Y electrode.

The coordinate detecting circuit 60 detects the coordinates of a touch point in the touch sensor region 10 where an observer has touched with the stylus pen 500, based on the location of a Y electrode to which the L-level voltage has been supplied and current values detected in the X electrodes. This allows the touch panel 400 of this embodiment to detect a plurality of touch points touched by an observer.

As described, in the first embodiment where the coordinates of a point in the touch sensor region 10 touched by an observer is detected by detecting a capacitance difference between coupling capacitors of an X electrode and a Y electrode, a parasitic capacitance between the X electrode and the Y electrode can be canceled out.

This embodiment is consequently capable of detecting a point that is touched by an observer with the stylus pen 500 without being affected by a parasitic capacitance between an X electrode and a Y electrode due to arrangement variations which accidentally occur in the course of manufacture, and by fluctuations in parasitic capacitance between the X electrode and the Y electrode due to external factors such as the temperature.

Increasing the X electrodes and the Y electrodes in number generally reduces the coupling capacitances of the X electrodes and the Y electrodes that are read when an observer touches the touch sensor region 10 with the stylus pen 500. In this embodiment, on the other hand, a parasitic capacitance between an X electrode and a Y electrode is cancelled out so that smaller coupling capacitances of the X electrode and the Y electrode can be detected, which makes a high-resolution touch panel with more electrodes possible.

### Second Embodiment

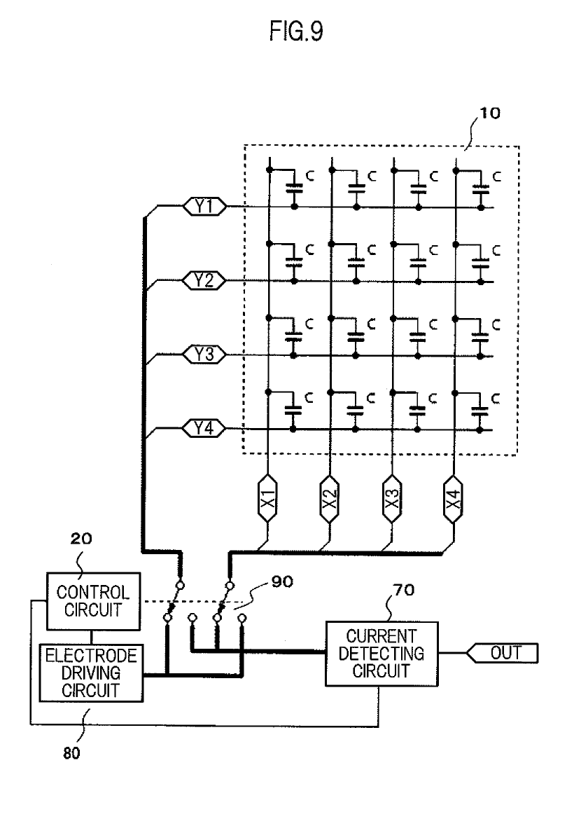

FIG. 9 is a block diagram illustrating a schematic structure of a touch panel that is used in a liquid crystal display device of a second embodiment of the present invention.

In FIG. 9, a touch sensor region is denoted by 10, a control circuit is denoted by 20, a current detecting circuit is denoted by 70, and an electrode driving circuit is denoted by 80.

In the embodiment described above, the coordinates of a point are detected by detecting currents that flow in the respective X electrodes as a result of supplying the L-level voltage to the Y electrodes sequentially in a time division manner. In this embodiment, the control circuit 20 controls a switch 90 in a manner that causes, in a period A, the electrode driving circuit 80 to supply the L-level voltage to the Y electrodes sequentially in a time division manner and the current detecting circuit 70 to detect currents that flow in all of the X electrodes, and in a manner that causes, in a period B, the electrode driving circuit 80 to supply the L-level voltage to the X electrodes sequentially in a time division manner and the current detecting circuit 70 to detect currents that flow in all of the Y electrodes. A coordinate detecting circuit placed downstream of the current detecting circuit 70 is omitted from FIG. 9.

In this embodiment, current values detected in all of the X electrodes in the period A are in proportion to the capacitance difference between coupling capacitors that one of two consecutive Y electrodes forms with all of the X electrodes and coupling capacitors that the other of the two consecutive Y electrodes forms with all of the X electrodes.

The location of a Y electrode in the touch sensor region 10 where an observer has touched with the stylus pen 500 can thus be detected in the period A. Similarly, the touch panel can detect the location of an X electrode in the touch sensor region 10 where an observer has touched with the stylus pen 500 based on current values that are detected in all of the Y electrodes in the period B.

The coordinates of a touch point in the touch sensor region 10 touched by an observer is detected in this manner. This allows the touch panel of this embodiment to detect a plurality of touch points touched by an observer.

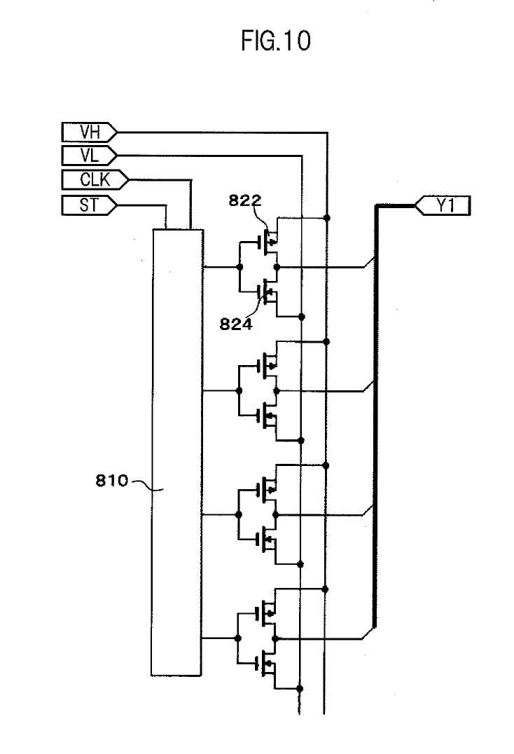

FIG. 10 is a diagram illustrating an example of the electrode driving circuit 80 of FIG. 9.

In FIG. 10, denoted by 810 is a shift register; 822, pMOS transistors; and 824, nMOS transistors. A bold line of FIG. 10 indicates a bus connection. The electrode driving circuit 80 illustrated in FIG. 10 has the same circuit structure as that of the Y driving circuit 30 illustrated in FIG. 6.

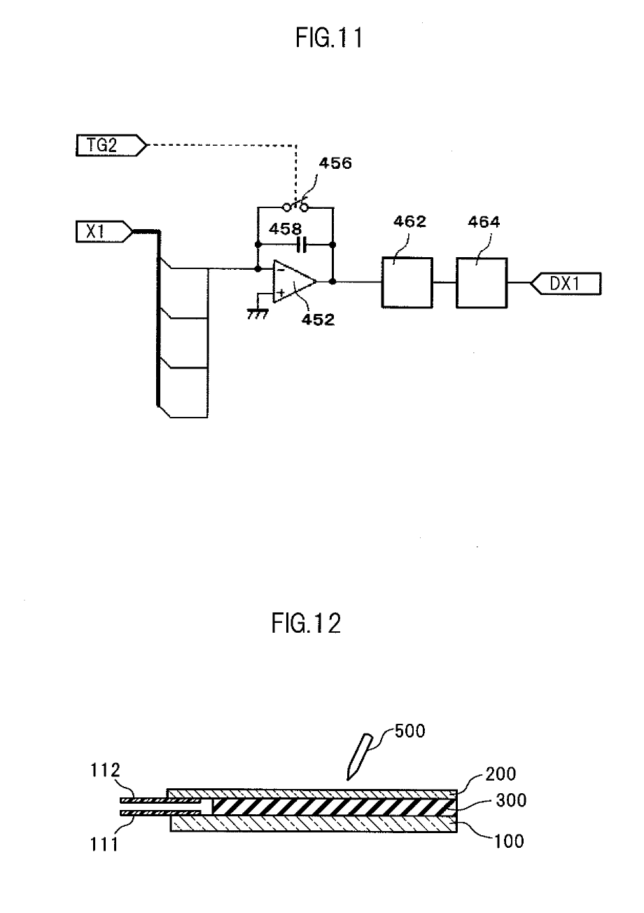

FIG. 11 is a diagram illustrating an example of the current detecting circuit 70 of FIG. 9. A bold line of FIG. 11, too, indicates a bus connection.

In the current detecting circuit 70 structured as illustrated in FIG. 11, an integration circuit including an operational amplifier 452 and an integration capacitor 458 integrates currents that flow in all electrodes (all of the X electrodes or all of the Y electrodes). A switching device 456 is turned on with a timing pulse TG1, and the integration capacitor 458 is reset when a switching device 456 is on. In FIG. 11, a sample-and-hold circuit is denoted by 462 and an A/D conversion circuit is denoted by 464.

### Third Embodiment

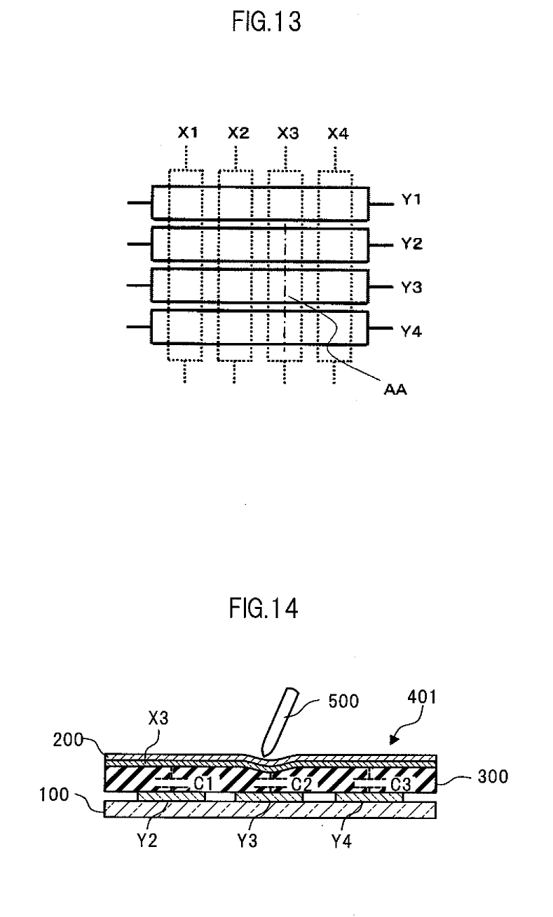

FIGS. 12 to 14 are diagrams about a display device with a touch panel according to a third embodiment of the present invention. FIG. 12 is a sectional view illustrating a schematic structure of a touch panel that is incorporated in the display device with a touch panel. FIG. 13 is a plan view illustrating an electrode pattern of the touch panel of FIG. 12. FIG. 14 is a sectional view that is an enlarged view of part of FIG. 12.

The display device with a touch panel according to the third embodiment basically has the same structure as that of the first embodiment described above, except for the touch panel structure.

The touch panel 400 of the first embodiment has a structure illustrated in FIG. 3 where the X electrodes (X1 to X4) and the Y electrodes (Y1 to Y4) are formed on the side of the first substrate 100 and the counter electrode 201 is formed on the side of the second substrate 200. A touch panel 401 of the third embodiment has a structure illustrated in FIG. 14 where Y electrodes (Y1 to Y4) are formed on the side of the first substrate 100 and X electrodes (X1 to X4) are formed on the side of the second substrate 200. Given below is a description on the touch panel 401 of the third embodiment.

The touch panel 401 includes, as illustrated in FIG. 12, the first and second substrates (100 and 200, respectively), which are arranged to face each other, the gel-like sheet 300, which is held between the first substrate 100 and the second substrate 200, a flexible printed circuit (FPC) board 111, which is fixed at one end to one of the four sides of a substrate opposing face of the first substrate 100 (a face that is opposed to the second substrate 200), and a flexible printed circuit (FPC) board 112, which is fixed at one end to one of the four sides of a substrate opposing face of the second substrate 200 (a face that is opposed to the first substrate 100). The touch panel 401 includes the touch panel region (touch sensor region) 10 illustrated in FIG. 2.

As illustrated in FIG. 13, the touch panel 401 includes a plurality of X electrodes (X1 to X4), which run in a first direction (for example, Y direction) while maintaining a given width and are arranged side by side at a given alignment pitch in a second direction (for example, X direction) intersecting the first direction, and a plurality of Y electrodes (Y1 to Y4), which run in the second direction while maintaining a given width to intersect with the X electrodes and are arranged side by side at a given alignment pitch in the first direction. The Y electrodes (Y1 to Y4) and the X electrodes (X1 to X4) stretch inside and outside the touch panel region 10.

As illustrated in FIG. 14, the first substrate 100 includes the Y electrodes (Y1 to Y4), which are formed on a face of the first substrate 100 that is opposed to the second substrate 200. The second substrate 200 includes the X electrodes (X1 to X4), which are formed on a face of the second substrate 200 that is opposed to the first substrate 100.

The Y electrodes (Y1 to Y4) and the X electrodes (X1 to X4) are laminated on top of each other with the gel-like sheet 300 interposed therebetween. The gel-like sheet 300 is formed so as to cover at least all of the Y electrodes and the X electrodes within the touch panel region 10. The gel-like sheet 300 of the third embodiment, too, is formed on the side of the second substrate 200, but the placement of the gel-like sheet 300 is not limited thereto.

The touch panel 401 of this embodiment has the counter electrode 201 of the first embodiment on neither the first substrate 100 nor the second substrate 200.

The X electrodes (X1 to X4) and the Y electrodes (Y1 to Y4) are formed from a transparent conductive material such as indium tin oxide (ITO).

The substrates employed as the first substrate 100 and the second substrate 200 are transparent insulating substrates. The first and second substrates (100 and 200) of this embodiment are glass substrates, and the second substrate 200 is thinner than the first substrate 100.

The material of the gel-like sheet 300 can be paraffin-based oil or a silicone rubber-based material, for example.

FIG. 14 schematically illustrates that capacitors C1, C2, and C3 are formed between the X electrode X3 and the Y electrode Y2, between the X electrode X3 and the Y electrode Y3, and between the X electrode X3 and the Y electrode Y4, respectively.

When an observer touches a touch face of the touch panel 401 (the touch face of the second substrate 200) with the stylus pen 500 as illustrated in FIG. 14, the second substrate 200 is deformed and the deformation is followed up by the displacement of the gel-like sheet 300 (a change in thickness of the gel-like sheet 300), which changes the capacitance between the Y electrode on the first substrate 100 and the X electrode on the second substrate 200. In FIG. 14 where an area above the Y electrode Y3 and the X electrode X3 is touched with the stylus pen 500, the capacitance between the Y electrode Y3 and the X electrode X3 changes. As in the first embodiment, this change in capacitance is detected to detect a point that the stylus pen has touched.

The above-mentioned change in capacitance is caused by the displacement of the gel-like sheet 300. Touch input is therefore accomplished also with an observer's finger, a stick with a rounded tip, or the like.

Further, the presence or absence of a touch is detected from a change in capacitance, and hence a contact between electrodes as in resistive touch panels is avoided and the touch panel 401 can therefore have high reliability.

Consequently, the third embodiment, too, can provide a display device with a highly reliable, capacitive touch panel that can process finger touch input and stylus pen input.

The electrode pattern on the first substrate and the electrode pattern on the second substrate can be made inconspicuous by giving the gel-like sheet 300 a refractive index approximately equal to that of the first and second substrates.

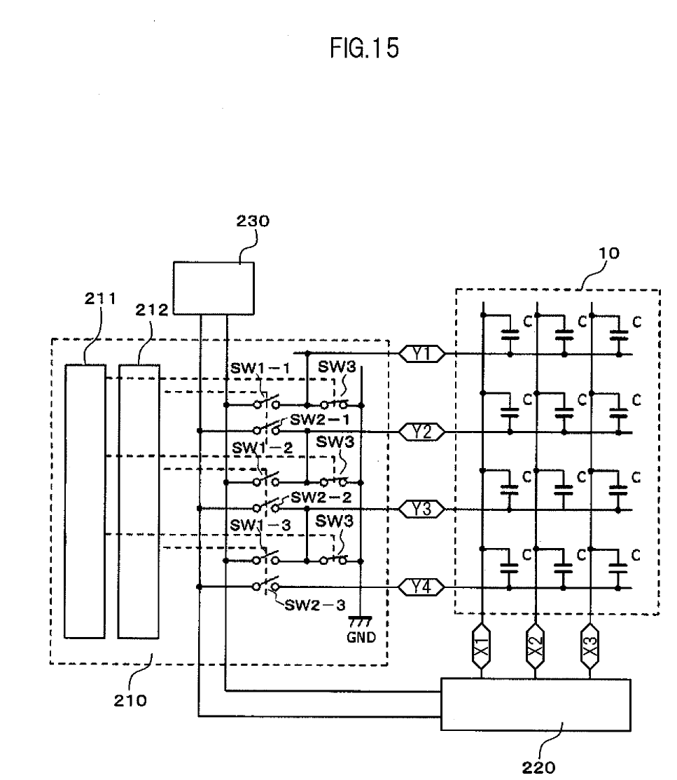

FIG. 15 is a block diagram illustrating the schematic structure of the touch panel according to the third embodiment of the present invention.

In FIG. 15, a touch sensor region is denoted by 10, a Y electrode selecting circuit is denoted by 210, an X electrode selecting circuit is denoted by 220, and a current detecting circuit is denoted by 230. The Y electrode selecting circuit 210 and the X electrode selecting circuit 220 have the same circuit structure. In FIG. 15, only the circuit structure of the Y electrode selecting circuit 210 is illustrated.

The Y electrode selecting circuit 210 and the X electrode selecting circuit 220 each include a scanning circuit 211 and a scanning circuit 212. The scanning circuit 212 turns off all switching devices SW3 in the period A and turns on all the switching devices SW3 in the period B.

The scanning circuit 211 sequentially controls, in a time division manner, ON and OFF of a switching device SW1 and a switching device SW2 corresponding to adjacent electrodes (Y electrodes or X electrodes) in the period A and turns off all switching devices SW1 and all switching devices SW2 in the period B. For example, in a first time division period of the period A, the scanning circuit 211 turns on a switching device SW1-1, turns on a switching device SW2-1, and turns off the remaining switching devices SW1 and SW2.

In the next time division period, the scanning circuit 211 turns on a switching device SW1-2, turns on a switching device SW2-2, and turns off the remaining switching devices SW1 and SW2. Thereafter, the scanning circuit 211 selects the electrodes (Y electrodes or X electrodes) in the same manner.

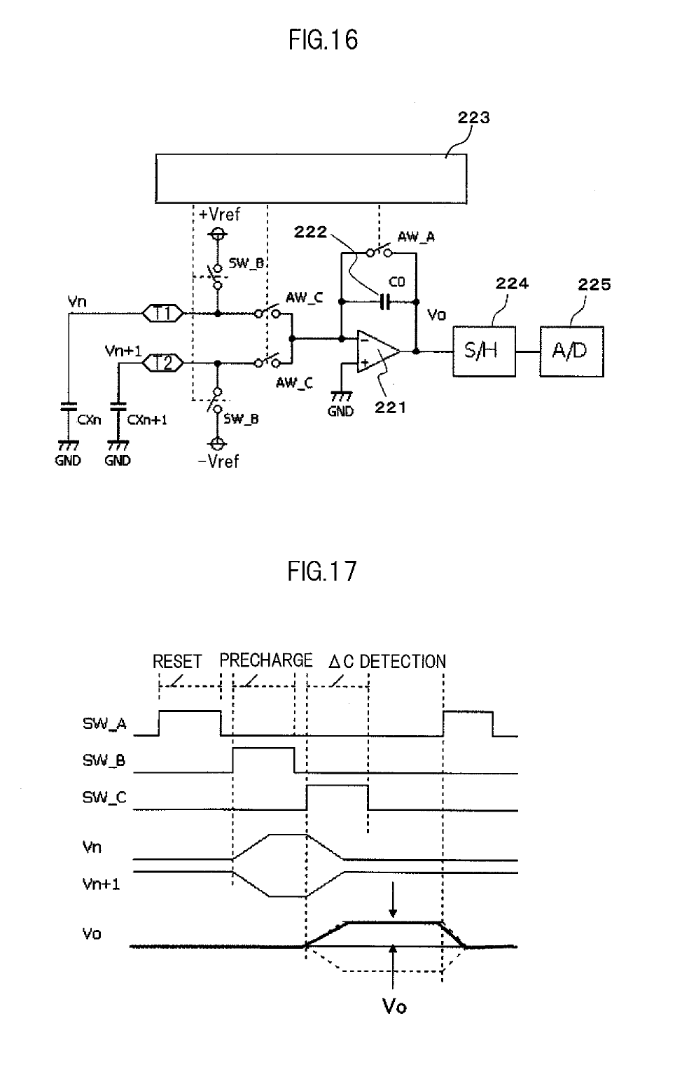

FIG. 16 is a diagram illustrating an example of the current detecting circuit 230 illustrated in FIG. 15.

In FIG. 16, an operational amplifier is denoted by 221, an integral capacitor is denoted by 222, a switch control circuit is denoted by 223, a sample-and-hold circuit is denoted by 224, and an A/D conversion circuit is denoted by 225. In FIG. 16, adjacent two electrodes of the X electrodes or the Y electrodes are denoted by T1 and T2.

FIG. 17 is a timing chart for describing the way the current detecting circuit 230 of FIG. 16 operates.

In the following description, assuming that the electrodes Y1 and Y2 are connected to T1 and T2 of FIG. 16 (hereinafter, assumption A), operations of the current detecting circuit 230 illustrated in FIG. 16 are described.

In the case of the assumption A, the switching device SW1-1 is on, the switching device SW2-1 is on, the remaining switching devices SW1 and switching devices SW2 are off, and all the switch elements SW3 are off in the Y electrode selecting circuit 210.

All the switching devices SW1 and all the switching devices SW2 are off and all the switching devices SW3 are on in the X electrode selecting circuit 220. A reference voltage (GND) is supplied to all the X electrodes.

As illustrated in FIG. 17, first, under the control by the switch control circuit 223, a switching device SW_A is turned on and the integral capacitor 222 is reset. Then, under the control by the switch control circuit 223, the switching device SW_B is turned on, a high potential (+Vref) positive polarity pulse having a voltage level higher than the reference voltage (GND) is supplied to the electrode Y1, and a low potential (−Vref) negative polarity pulse having a voltage level lower than the reference voltage (GND) is supplied to the electrode Y2. Thereafter, under the control by the switch control circuit 223, a switching device SW_C is turned on and a voltage Vo is obtained from an integration circuit including the operational amplifier 221 and the integral capacitor 222.

Vo is represented by the following equation (1):

[Equation 1]

Vo=Vref/Co×(Cn+1−Cn) (1)

where Co is a capacitance value of the integral capacitor 222, Cn is coupling capacitors between one of adjacent two Y electrodes (here, electrode Y1) and all the X electrodes, and Cn+1 is coupling capacitors between the other of the adjacent two electrodes (here, electrode Y2) and all the X electrodes. When adjacent two electrodes among the X electrodes are connected to T1 and T2 of FIG. 16, Cn is coupling capacitors between one of the adjacent two X electrodes and all the Y electrodes and Cn+1 is coupling capacitors between the other of the adjacent two X electrodes and all the X electrodes.

In this way, current values detected in all the X electrodes are proportional to the capacitance difference between the coupling capacitors that one of the two consecutive Y electrodes forms with all the X electrodes and the coupling capacitors that the other of the two consecutive Y electrodes forms with all the X electrodes.

Therefore, in the period A, the reference voltage (GND) is supplied to all the X electrodes, adjacent two electrodes among the Y electrodes are sequentially selected in a time division manner, and a positive polarity pulse is supplied to one of the adjacent two electrodes and a negative polarity pulse is supplied to the other thereof. This makes it possible to detect a position of the Y electrodes in the touch sensor region 10 touched by the observer with the stylus pen 500.

Similarly, in the period B, the reference voltage (GND) is supplied to all the Y electrodes, adjacent two electrodes among the X electrodes are sequentially selected in a time division manner, a positive polarity pulse is supplied to one of the adjacent two electrodes, and a negative polarity pulse is supplied to the other thereof. This makes it possible to detect a position of the X electrodes in the touch sensor region 10 touched by the observer with the stylus pen 500.

Consequently, it is possible to detect coordinates of a touch point in the touch sensor region 10 touched by the observer. In this case, in this embodiment, it is possible to detect a plurality of touch points touched by the observer.

The touch panel of the third embodiment may be driven by the driving method that is employed in the first embodiment. Similarly, the touch panel of the third embodiment may be driven by the driving method that is employed in the second embodiment.

The first to third embodiments describe a case of using glass substrates as the first and second substrates (100 and 200). The first and second substrates (100 and 200) may instead be plastic substrates made of an insulating resin. Alternatively, the first substrate 100 may be a glass substrate while a plastic substrate is used as the second substrate 200.

The first to third embodiments describe a case of placing the gel-like sheet 300 on the side of the second substrate 200. The gel-like sheet 300 may instead be placed on the side of the first substrate 100.

The descriptions given above are of embodiments in which the present invention is applied to a liquid crystal display device. However, the present invention is not limited thereto, and is applicable to display devices in general including organic EL display devices.

While there have been described what are at present considered to be certain embodiments of the invention, it is understood that various modifications may be made thereto, and it is intended that the appended claims cover all such modifications as fall within the true spirit and scope of the invention.

What is claimed is:

1. A display device with a touch panel, comprising:
a display panel; and
a capacitive touch panel which is placed on an observer side of the display panel,
wherein the touch panel includes a first substrate and a second substrate which are arranged to face each other,
wherein the first substrate includes on a surface thereof, which is opposed to the second substrate:
a plurality of first electrodes which extend in a first direction and are arranged side by side in a second direction intersecting the first direction; and
a plurality of second electrodes which extend in the second direction to intersect the plurality of first electrodes and are arranged side by side in the first direction,
wherein the second substrate includes on a surface thereof, which is opposed to the first substrate a planar third electrode which covers the plurality of first electrodes and the plurality of second electrodes, and
wherein the display device includes a gel-like sheet interposed between the plurality of first electrodes and the plurality of second electrodes, and the third electrode.

2. A display device with a touch panel according to claim 1, wherein the gel-like sheet has a hardness of 2 or more and 15 or less.

3. A display device with a touch panel according to claim 1,
wherein the first substrate and the second substrate each comprise a glass substrate, and
wherein the second substrate is thinner than the first substrate.

4. A display device with a touch panel according to claim 1,
wherein the first substrate comprises a glass substrate, and
wherein the second substrate comprises a plastic substrate.

5. A display device with a touch panel according to claim 1, wherein the first substrate and the second substrate each comprise a plastic substrate.

6. A display device with a touch panel according to claim 1, further comprising:
a driving circuit;
a detecting circuit; and
a coordinate position calculating circuit which calculates a touch point at which the touch panel is touched,
wherein the driving circuit sequentially selects two first electrodes among the plurality of first electrodes to supply a voltage higher in potential than a reference voltage to one of the selected two first electrodes and supply the reference voltage to another thereof,
wherein the detecting circuit detects a capacitance difference between a capacitor A and a capacitor B (A-B), the capacitor A being provided between a second electrode that is selected among the plurality of second electrodes and the first electrode to which the voltage higher in potential is supplied, the capacitor B being provided between the selected second electrode and the first electrode to which the reference voltage is supplied, and
wherein the coordinate position calculating circuit calculates a touch point at which the touch panel is touched based on locations of the selected two first electrodes and the selected second electrode and on the capacitance difference (A-B).

7. A display device with a touch panel according to claim 1, further comprising:
a driving circuit;
a detecting circuit; and
a coordinate position calculating circuit which calculates a touch point at which the touch panel is touched,
wherein, in a period A, the driving circuit sequentially selects two first electrodes among the plurality of first electrodes to supply a voltage higher in potential than a reference voltage to one of the selected two first electrodes and supply the reference voltage to another thereof and, in a period B, the driving circuit sequentially selects two second electrodes among the plurality of second electrodes to supply a voltage higher in potential than the reference voltage to one of the selected two second electrodes and supply the reference voltage to another thereof,
wherein, in the period A, the detecting circuit detects a capacitance difference between a capacitor A and a capacitor B (A-B), the capacitor A being provided between each of the selected two second electrodes and the first electrode to which the voltage higher in potential is supplied, the capacitor B being provided between the each of the selected two second electrodes and the first electrode to which the reference voltage is supplied, and in the period B, the detecting circuit detects a capacitance difference between a capacitor C and a capacitor D (C-D), the capacitance C being provided between each of the selected two first electrodes and the second electrode to which the voltage higher in potential is supplied, the capacitor D being provided between each of the selected two first electrodes and the second electrode to which the reference voltage is supplied, and
wherein the coordinate position calculating circuit calculates a touch point at which the touch panel is touched based on the selected two first electrodes and the capacitance difference (A-B), and based on the selected two second electrodes and the capacitance difference (C-D).

8. A display device with a touch panel according to claim 1, further comprising:
a first electrode selecting circuit;
a second electrode selecting circuit;
a detecting circuit; and
a coordinate position calculating circuit which calculates a touch point at which the touch panel is touched,
wherein, in a period A, the first electrode selecting circuit sequentially selects two first electrodes among the plurality of first electrodes to supply a positive pulse higher in potential than a reference voltage to one of the selected two first electrodes and supply a negative pulse lower in potential than the reference voltage to another thereof,
wherein, in a period B, the second electrode selecting circuit sequentially selects two second electrodes among the plurality of second electrodes to supply a positive pulse higher in potential than the reference voltage to one of the selected two second electrodes and supply a negative pulse lower in potential than the reference voltage to another thereof,
wherein, in the period A, the detecting circuit detects a capacitance difference between a capacitor A and a capacitor B (A-B), the capacitor A being provided between each of the selected two second electrodes and the first electrode to which the positive pulse is supplied, the capacitor B being provided between each of the selected two second electrodes and the first electrode to which the negative pulse is supplied, and in the period B, the detecting circuit detects a capacitance difference between a capacitor C and a capacitor D (C-D), the capacitor C being provided between each of the selected two first electrodes and the second electrode to which the positive pulse is supplied, the capacitor D being provided between each of the selected two first electrodes and the second electrode to which the negative pulse is supplied, and
wherein the coordinate position calculating circuit calculates a touch point at which the touch panel is touched based on the selected two first electrodes and the capacitance difference (A-B), and based on the selected two second electrodes and the capacitance difference (C-D).

9. A display device with a touch panel according to claim 1, wherein the display panel comprises an IPS liquid crystal display panel.

10. A display device with a touch panel, comprising:
a display panel; and
a capacitive touch panel which is placed on an observer side of the display panel,
wherein the touch panel includes a first substrate and a second substrate which are arranged to face each other,
wherein the first substrate includes on a surface thereof, which is opposed to the second substrate a plurality of first electrodes which extend in a first direction and are arranged side by side in a second direction intersecting the first direction,
wherein the second substrate includes on a surface thereof, which is opposed to the first substrate a plurality of second electrodes which extend in the second direction to intersect the plurality of first electrodes and are arranged side by side in the first direction, and
wherein the display device includes a gel-like sheet interposed between the plurality of first electrodes and the plurality of second electrodes.

11. A display device with a touch panel according to claim 10, wherein the gel-like sheet has a hardness of 2 or more and 15 or less.

12. A display device with a touch panel according to claim 10,
wherein the first substrate and the second substrate each comprise a glass substrate, and
wherein the second substrate is thinner than the first substrate.

13. A display device with a touch panel according to claim 10,
wherein the first substrate comprises a glass substrate, and
wherein the second substrate comprises a plastic substrate.

14. A display device with a touch panel according to claim 6, wherein the first substrate and the second substrate each comprise a plastic substrate.

15. A display device with a touch panel according to claim 10, further comprising:
a driving circuit;
a detecting circuit; and
a coordinate position calculating circuit which calculates a touch point at which the touch panel is touched,
wherein the driving circuit sequentially selects two first electrodes among the plurality of first electrodes to supply a voltage higher in potential than a reference voltage to one of the selected two first electrodes and supply the reference voltage to another thereof,
wherein the detecting circuit detects a capacitance difference between a capacitor A and a capacitor B (A-B), the capacitor A being provided between a second electrode that is selected among the plurality of second electrodes and the first electrode to which the voltage higher in potential is supplied, the capacitor B being provided between the selected second electrode and the first electrode to which the reference voltage is supplied, and
wherein the coordinate position calculating circuit calculates a touch point at which the touch panel is touched based on locations of the selected first electrodes and the selected second electrode and on the capacitance difference (A-B).

16. A display device with a touch panel according to claim 10, further comprising:
a driving circuit;
a detecting circuit; and
a coordinate position calculating circuit which calculates a touch point at which the touch panel is touched,
wherein, in a period A, the driving circuit sequentially selects two first electrodes among the plurality of first electrodes to supply a voltage higher in potential than a reference voltage to one of the selected two first electrodes and supply the reference voltage to another thereof and, in a period B, the driving circuit sequentially selects two second electrodes among the plurality of second electrodes to supply a voltage higher in potential than the reference voltage to one of the selected two second electrodes and supply the reference voltage to another thereof,
wherein, in the period A, the detecting circuit detects a capacitance difference between a capacitor A and a capacitor B (A-B), the capacitor A being provided between each of the selected two second electrodes and the first electrode to which the voltage higher in potential is supplied, the capacitor B being provided between the each of the selected two second electrodes and the first electrode to which the reference voltage is supplied, and in the period B, the detecting circuit detects a capacitance difference between a capacitor C and a capacitor D (C-D), the capacitance C being provided between each of the selected two first electrodes and the second electrode to which the voltage higher in potential is supplied, the capacitor D being provided between each of the selected two first electrodes and the second electrode to which the reference voltage is supplied, and
wherein the coordinate position calculating circuit calculates a touch point at which the touch panel is touched based on the selected two first electrodes and the capacitance difference (A-B), and based on the selected two second electrodes and the capacitance difference (C-D).

17. A display device with a touch panel according to claim 10, further comprising:
a first electrode selecting circuit;
a second electrode selecting circuit;
a detecting circuit; and
a coordinate position calculating circuit which calculates a touch point at which the touch panel is touched,
wherein, in a period A, the first electrode selecting circuit sequentially selects two first electrodes among the plurality of first electrodes to supply a positive pulse higher in potential than a reference voltage to one of the selected two first electrodes and supply a negative pulse lower in potential than the reference voltage to another thereof,
wherein, in a period B, the second electrode selecting circuit sequentially selects two second electrodes among the plurality of second electrodes to supply a positive pulse higher in potential than the reference voltage to one of the selected two second electrodes and supply a negative pulse lower in potential than the reference voltage to another thereof,
wherein, in the period A, the detecting circuit detects a capacitance difference between a capacitor A and a capacitor B (A-B), the capacitor A being provided between each of the selected two second electrodes and the first electrode to which the positive pulse is supplied, the capacitor B being provided between each of the selected two second electrodes and the first electrode to which the negative pulse is supplied, and in the period B, the detecting circuit detects a capacitance difference between a capacitor C and a capacitor D (C-D), the capacitor C being provided between each of the selected two first electrodes and the second electrode to which the positive pulse is supplied, the capacitor D between each of the selected two first electrodes and the second electrode to which the negative pulse is supplied, and
wherein the coordinate position calculating circuit calculates a touch point at which the touch panel is touched based on the selected two first electrodes and the capacitance difference (A-B), and based on the selected two second electrodes and the capacitance difference (C-D).

18. A display device with a touch panel according to claim 10, wherein the display panel comprises an IPS liquid crystal display panel.
